(19) United States
(12) Patent Application Publication
(10) Pub. No.: US 2006/0268866 A1
(43) Pub. Date: Nov. 30, 2006

(54) Out-of-order superscalar IP packet analysis

(76) Inventor: Simon Lok, Vero Beach, FL (US)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 11/432,028

(22) Filed: May 10, 2006

Related U.S. Application Data
(60) Provisional application No. 60/594,907, filed on May 17, 2005.

(51) Int. Cl. H04L 12/56

(52) U.S. Cl. 370/389

(57) ABSTRACT

An out-of-order network packet analysis architecture that decouples deep packet inspection from the packet forwarding process. Rather than placing the packet inspection engine inline into the packet forwarding pipeline, the packet forwarding and packet inspection processes operate asynchronously on a single unified packet buffer. Furthermore, the present invention reduces the load on the packet inspection engine by employing a packet marking preprocessor to designate appropriate packets for inspection.

This application claims the benefit of U.S. Provisional Patent Application Ser. No. 60/594,907 filed on May 17, 2005, the specification of which is incorporated herein by reference.

### FIELD OF THE INVENTION

The present invention relates, in general, to network data communications, and, more particularly, to software, systems and methods for inspecting packet traffic in a packet communication network.

### RELEVANT BACKGROUND

Deep inspection and analysis of IP packets is becoming an increasingly important tactic in the world of network defense. Traditional network architectures employ static firewalls that merely inspect packet headers to enforce traffic policies via filtering. Modern threats include attacks that can easily bypass simple filtering policies by tunneling malicious traffic through patterns typically allowed by most firewall configurations.

In response to this threat, intrusion detection and prevention systems as well as content filtering systems have begun to perform deep packet inspection which involves inspection of packet payloads in addition to headers to enforce more comprehensive network defense policies. Examples of such systems include those offered by Bluesocket, Symantec, Nomadics, Packeteer and others.

Deep inspection of packets is a particularly difficult challenge for packet processors because of the need for real-time or near-real-time packet forwarding. Almost all of the network activities that users normally engage in require that packets be forwarded expediently with minimal delay, or at least predictably uniform delay. Although a residential user may be willing to accept a high latency network as a simple fact of life, the typical corporate user will find such a delay unacceptable. In particular, real-time communications applications (e.g., instant messaging, gaming) become difficult if not impossible to use effectively in high-latency and/or variable latency environments. Multimedia network activities (e.g., VoIP, VoD) have even tighter tolerances, sometimes as low as 250 ms end-to-end for correct operation.

Accordingly, a need exists for systems, methods and software that enable the identification of network packets that are outside a preselected boundary.

### SUMMARY OF THE INVENTION

Briefly stated, the present invention involves an out-of-order IP packet analysis architecture that decouples deep packet inspection from the packet forwarding process. Rather than placing the packet inspection engine inline into the packet forwarding pipeline, the packet forwarding and packet inspection processes operate asynchronously on a single unified packet buffer. Furthermore, the present invention reduces the load on the packet inspection engine by employing a packet marking preprocessor to designate appropriate packets for inspection. When combined with a decoupled architecture, described in provisional patent application Ser. No. ______ the out-of-order inspection system is capable of providing a higher throughput with a lower latency than existing architectures.

### BRIEF DESCRIPTION OF THE DRAWINGS

FIG. 1 illustrates a prior art Packet Inspection Architecture;

FIG. 2 illustrates an Out-of-bound Packet Inspection Architecture in accordance with the present invention;

FIG. 3 shows Unified Packet Buffer Pointers Under Normal Network Load; and

FIG. 4 illustrates Unified Packet Buffer Pointers Under Heavy Network Load.

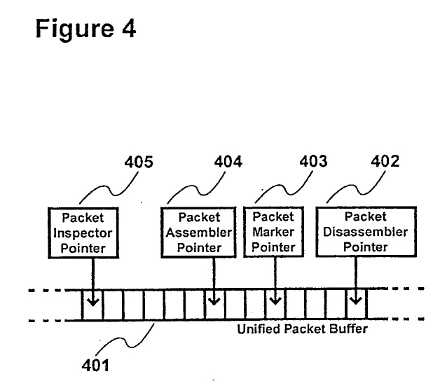

### DETAILED DESCRIPTION OF THE PREFERRED EMBODIMENTS

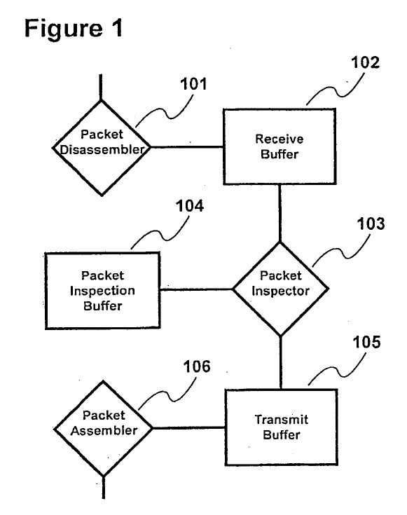

FIG. 1 shows a traditional packet inspection architecture in which inbound packets arrive at an interface which passes wire format packets (i.e., packets that comply with a particular physical network protocol) to a packet disassembler 101 which processes packets and places them into a receive buffer 102. Network packets comprise a plurality of protocol-specified fields such as header fields and data fields that are arranged in a particular order. Packet disassembler 101 functions to identify these fields and store them in receive buffer 102 in a manner that allows the fields to be accessed for inspection.

The packet inspection engine 103 copies packets or particular fields from the packets from the receive buffer 102 into the packet inspection buffer 104 for inspection. The inspection engine then inspects packets sequentially in the order in which they were received.

Once inspection is complete, packets are then placed into a transmit buffer where they are then assembled into wire format and forwarded out to an appropriate interface (e.g., an interface suitable for delivering the assembled packet to a desired destination process). When the packet inspection is performed as part of a policy enforcement engine (e.g., content filtering), then the inspection engine may choose to not forward the packets on to the transmit buffer or forward modified packets into the transmit buffer depending on the result of the inspection. Packets that are not forwarded may be discarded, held for later inspection, forwarded to an alternative destination process for inspection, or other remedial action. Packet assembler 106 reads packets from transmit buffer 105 and translates them into an appropriate wire format before being forwarded out the appropriate interface.

A significant problem is congestion. Since the packet inspection engine may take an arbitrarily long time to inspect packets, the receive buffer may fill up with backlogged packets. This is particularly problematic for deep inspection in which the inspection engine 103 may be tasked with interpreting multiple protocol layers and large amounts of data and header information. When this happens, the packet disassembly system is no longer able to receive packets. Typically, connection-based traffic (e.g., TCP) can recover because acknowledgments are not sent by the inspection device, forcing the transmitting nodes to retransmit. However, connectionless (e.g. UDP) packets will typically be dropped. Unless the network application has inherent retransmit support (e.g. NFS), packets simply will be lost forever. Furthermore, packets that are forwarded may spend an arbitrarily long time in the device. Since packet assembly and transmission follow packet inspection, the latency in packet forwarding is driven by the ability of the packet inspector to process packets in a timely fashion.

The traditional inspection architecture is a particular hindrance in converged networks that deliver multimedia over a single network link. In such a network, UDP VoIP packets will be arriving at the inspection device at the same time as TCP web traffic. Typically, inspection of the UDP VoIP packets is unnecessary because the data contents of a VoIP packet are unlikely to contain malicious content. However, in the traditional architecture, inspection is unavoidable because the packet inspector does not discriminate between VoIP packets and any other packet. Furthermore, when the TCP web traffic is difficult to inspect (e.g., because the content is compressed) or has a broad context (e.g., if somebody is downloading a full size CDROM image over HTTP), the UDP VoIP packets will be lost, ultimately resulting in the VoIP call being dropped.

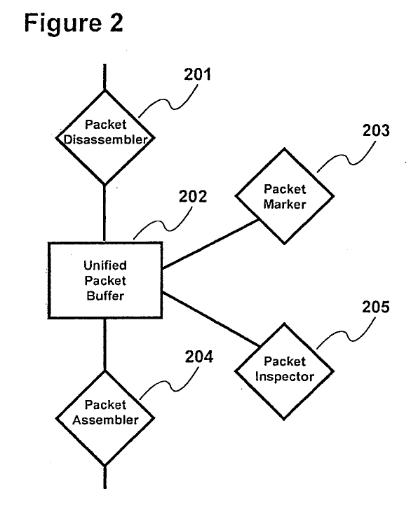

FIG. 2 illustrates an out-of-order packet inspection architecture in accordance with the present invention. Unlike the traditional architecture illustrated in FIG. 1, the out-of-order packet analysis architecture permits the packets to be inspected in random order.

Inbound packets are handled by an interface driver that passes wire format packets to the packet disassembler 201 which processes packets and places them into a unified packet buffer 202. The packet disassembly process includes the copying of packet headers and payload to the appropriate sections of a data structure to permit easy access to fields by the packet inspection engine.

Packet marker process 203 identifies relevant packets (i.e., packets for which deep inspection is desired and/or required) in the unified packet buffer 202 and labels them for the packet inspector 205 to inspect. In order to maintain high throughput, the packet marker performs a relatively cursory analysis of the packet based on, for example, the packet header, network instrumentation, as well as statistical context.

Packet header information that the packet marker process 203 considers, include, but are not limited to, the packet type (i.e., TCP, UDP, ICMP), the source address, the destination address, the source port and the destination port. Network instruments and contextual statistics considered by the packet marker process 203, include, but are not limited to, the current number of streams that a node has open, the rate at which new streams are being opened, the ratio of local subnets to external CIDR blocks that a node is communicating with and the traffic history of the node at a given time of day.

Based on these criteria, the packet marker can make a relatively quick decision as to whether the packet warrants deep analysis. For example, if a node begins to sequentially open a very large number of streams to hosts on external CIDR blocks, the packet marker process 203 will choose to mark all such packets for deep inspection because that would appear to be viral behavior. Similarly, if a node begins to open streams to all ports of a given host, that would appear to be a port scan and the packet marker process 203 would mark the packets for deep inspection. Of course, packets can be marked for inspection by the packet marker process 203 for simple reasons as well. If the administrator chooses to filter all HTTP traffic for porn based on payload keyword matching, then all TCP responses from port 80 will be marked for deep inspection.

Packet assembler 204 asynchronously assembles and transmits packets from the unified packet buffer 202 that have either not been marked for inspection by the packet marker 203 or have been inspected by the packet inspector 205.

One feature of the present invention is that packet inspection is decoupled from (i.e., asynchronous) the forwarding of packets. Wire-format packets are received and transmitted to and from interfaces and a unified packet buffer asynchronously from packet inspection. Hence, packet inspection does not add latency, or variability in latency, to the process of packet forwarding. Furthermore, the decoupled nature of the scheduler lends itself to superscalar implementation that leverages multiprocessor hardware to parallelize the deep inspection processes.

Another feature of the present invention is that the process of inspection is divided into two phases, a fast mark phase that quickly identifies which packets require inspection and a deep inspection phase that actually performs the packet inspection. By having a packet marking process, the present invention identifies packets that will not require inspection and allow the packet assembler to efficiently forward them out of the device.

Strict control of the pointers and packet labeling in the unified packet buffer preserves the semantics of the traditional inline processing architecture. The packet marker pointer should not move ahead of the packet disassembler pointer as this would result in the marker analyzing invalid data. The packet inspector pointer must never move ahead of the packet marker pointer because the inspector would be depending on invalid marker labels to decide whether or not a packet needs to be inspected. The packet assembler pointer must never move ahead of the packet marker pointer because then packets that should be inspected may be forwarded out of the device prematurely. Although the packet assembler pointer is allowed to move ahead of the packet inspector pointer, only packets that are not marked for inspection can be transmitted. If this occurs, the packet assembler is also responsible for periodically running a sweep behind the packet inspector pointer to transmit packets that were skipped over previously.

By using a single unified packet buffer and dividing packet inspection into a fast mark process and a deep inspection process, the present invention provides an architecture that is uniquely capable of high throughput coupled with low latency that uniquely meets the demands of converged multimedia networks. The architecture of the present invention permits deep inspection of some packets while forwarding others with very low latency.

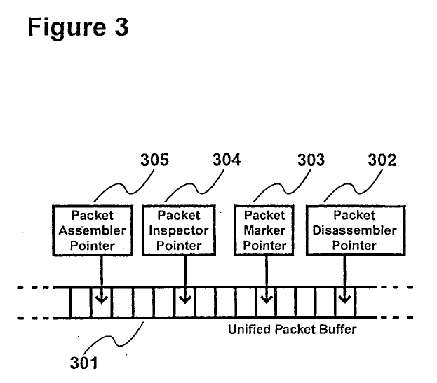

Under normal network load, as shown in FIG. 3, packets are first written into the unified packet buffer 301 by the packet disassembler 201 and tracked by packet disassembler pointer 302. The packet marker 203 uses packet marker pointer 303 to indicate whether or not each packet deposited by the packet disassembler 201 needs to be inspected and marks the packet accordingly. The packet inspector pointer 304 then follows the packet marker 303 and causes packet inspector 205 to perform inspection on the marked packets. Finally, the packet assembler pointer 305 causes packet assembler 204 to sweep up all packets and transmits them.

Under normal network load, as shown in FIG. 3, packets are first written into the unified packet buffer 301 by the packet disassembler 201 at the location indicated by the packet disassembler pointer 302. As packets are written into the unified packet buffer 301, the packet disassembler pointer 301 is incremented. The packet marker 203 analyzes packets at the packet marker pointer 303 and decides whether or not each packet deposited by the packet disassembler 201 needs to be inspected and marks the packet accordingly. After analyzing a packet, the packet marker pointer 303 is incremented in the same direction as the packet disassembler pointer 302. The packet inspector pointer 304 always follows the packet marker pointer 303 and determines the location where the packet inspector 205 performs deep inspection on packets marked by the packet marker 203.

After performing deep inspection, the packet inspector 205 increments the packet inspector pointer 304 in the same direction as the packet marker pointer 303 and packet disassembler pointer 302. Finally, the packet assembler pointer 305 which follows the packet inspector pointer 304 is used by the packet assembler 204 to determine the location of packets to be read out of the unified packet buffer 301 that are to be assembled into wire format for transmission. Once a packet is read, assembled and transmitted, the packet assembler 204 increments the packet assembler pointer 305 in the same direction as the packet inspector pointer 304, the packet marker pointer 303 and the packet disassembler pointer 302.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. Furthermore it is possible to have a multithreaded superscalar implementation of the packet inspector 206 that would have multiple packet inspector pointers 304 pointing to different positions within the unified packet buffer 301. So long as the packet inspector pointers 304 follow the packet marker pointer 303, the semantics of single threaded system are preserved.

What is claimed is:

1. An out-of-order packet analysis architecture comprising:
a packet inspection process operable to perform a selective packet inspection on network packets; and
a packet forwarding process that is decoupled from the packet inspection process and is operable to gather packets and forward them based on the inspection status of the packets.

2. The architecture of claim 1 wherein packet forwarding and packet inspection processes operate asynchronously using a shared unified packet buffer.

3. The architecture of claim 1 further comprising a packet marking preprocessor operable to designate appropriate packets for inspection.

4. The architecture of claim 1 wherein a plurality of packet inspection processes operate substantially independently.

5. The architecture of claim 1 wherein the architecture implements a firewall.

6. The architecture of claim 1 wherein the architecture implements a network access gateway.

7. The architecture of claim 1 wherein the architecture implements a network usage policy enforcement mechanism.

8. A method of packet analysis comprising:
receiving a packet for analysis;
performing deep packet inspection; and
forwarding the packet asynchronously of the deep packet inspection, wherein the forwarding is performed based on the completion status of the deep packet inspection.

9. The method of claim 8 wherein the deep packet inspection is performed simultaneously with the forwarding.

10. A system for processing data packets comprising:
an interface for receiving data packets from a physical connection and storing the data packets in a data structure;
a shared memory holding the data structure;
a first packet processor configured to forward the packet to a packet-specified destination; and
a second packet processor independent of the first packet processor and operable to perform a deep packet inspection on the packets.
